(19) United States
(12) Patent Application Publication
(10) Pub. No.: US 2026/0208228 A1
(43) Pub. Date: Jul. 23, 2026

(54) DISPENSING NOZZLES FOR VISCOUS MATERIAL

(71) Applicant: SPN DESIGN LIMITED, Hertfordshire (GB)

(72) Inventor: Adam DAVIES, Hertfordshire (GB)

(21) Appl. No.: 19/133,509

(22) PCT Filed: Nov. 16, 2023
(86) PCT No.: PCT/GB2023/053016

§ 371 Date: May 28, 2025

(30) Foreign Application Priority Data
Nov. 28, 2022 (GB) 2217831.3

(51) Int. Cl. B05C 17/005

(52) U.S. Cl. CPC B05C 17/00516; B05C 17/00513

(57) ABSTRACT

A dispensing nozzle (20, 40, 50) for a viscous material has a first end (21) and a second end (23). The first end (21) is provided with attachment means (22) adapted to secure the nozzle (20, 40, 50) to a dispensing gun or cartridge (29) housing the viscous material. The second end (23) has a dispensing tip (24) defining an outlet (25, 41, 51) for the viscous material. The outlet (25, 41, 51) has a profile comprising at least one straight edge. The nozzle (20, 40, 50) is further provided with a flange (26) extending longitudinally at least part way along an exterior surface defined between the first end (21) and the second end (23) of the nozzle (20, 40 50). The flange (26) projects radially from the exterior surface.

This invention relates, in a first aspect, to an improved nozzle for a dispensing gun or cartridge for viscous materials such as mastic. In a second aspect, the invention relates to a dispensing gun or cartridge fitted with such an improved nozzle. In a third aspect, the invention relates to a method of applying a viscous material to a surface using a dispensing gun or cartridge fitted with such an improved nozzle.

Dispensing guns for the application of viscous materials such as mastic, adhesive, or sealant to a surface are widely used in the construction industry, related trades, and in DIY. Such dispensing guns generally comprise a manually operated trigger which drives a plunger into a reservoir of the viscous material (often provided by way of a replaceable cartridge) in order to dispense the viscous material via a nozzle onto the desired surface. Conventional nozzles provided for this purpose are generally conical in shape, with a circular outlet defined at the dispensing tip, through which the viscous material is dispensed.

Although this conical, circular configuration of the nozzle and outlet has become standard, it does suffer from a number of shortcomings. In particular, this configuration results in excess amounts of the viscous material being dispensed onto the surface. The dispensed viscous material must then be further worked with finishing tools to provide the required finish and profile, and this process also involves the removal of significant amounts of the dispensed viscous material. This is wasteful both in terms of the amount of material discarded and in the labour time spent dispensing, finishing and discarding the waste material.

The present invention seeks to address the above issues by providing an improved nozzle capable of dispensing viscous material more accurately and which significantly reduces or eliminates the need for additional working and finishing of the viscous material after dispensing. The amount of waste viscous material can thus also be significantly reduced or eliminated.

According to a first aspect of the present invention there is provided a dispensing nozzle for a viscous material, comprising:
a first end having attachment means adapted to secure the nozzle to a dispensing gun or cartridge housing said viscous material;
a second end having a dispensing tip defining an outlet for the viscous material, said outlet having a profile comprising at least one straight edge; and
a flange extending longitudinally at least part way along an exterior surface defined between the first end and the second end of the nozzle, said flange projecting radially from said exterior surface.

The viscous material may be any construction material such as mastic, sealant, filler, putty, adhesive, caulk, grout, cement, mortar, silicone, resin, lubricant, paste, gel, or other viscous fluids or semi-solids used in the construction industry, related trades or DIY.

The attachment means preferably comprises an internal screw thread adapted to engage with a complementary external screw thread on a dispensing gun or cartridge. The nozzle may conveniently be provided together with one or more screw thread adaptors to enable attachment to dispensing guns or cartridges of differing sizes.

Alternatively, the attachment means may take the form of a snap-fit arrangement and/or a shaped base provided at the first end of the nozzle, such as those used with mastic foil pack applications.

The exterior surface of the nozzle preferably tapers from the first end to the second end. The dispensing tip outlet at the second end may desirably have a polygonal profile, such as a quadrilateral or triangular profile. Alternatively, depending on the particular application for which the nozzle is to be used, the outlet may have a generally semi-circular profile. The different outlet profiles may be selected according to the particular application, viscous material and surface.

In preferred embodiments of the present invention, the flange may project radially from the exterior surface of the nozzle at both sides thereof, and preferably has a depth of substantially 1.5 mm. The flange preferably defines, is colinear with, or is parallel to, at least one straight edge of the outlet.

In some embodiments, the longitudinal extension of the flange along the exterior surface of the nozzle may project beyond the outlet at the dispensing tip.

The flange is preferably configured so as to be easily cut, trimmed or removed if desired. In this way the shape and configuration of the flange can easily be adapted to suit the particular application for which the nozzle is to be used. The ability to cut the flange provides the capacity to set the depth to which the nozzle will penetrate within the substrate receiving the mastic, or other viscous material, whilst simultaneously providing the dispensed material with a smooth finish.

The dispensing tip of the nozzle itself may also preferably be configured so as to be easily cut or trimmed, giving further flexibility to the user in their choice of outlet and flange configuration. For example, a user may choose to shape the dispensing tip to adopt a different angle of the outlet, or a longer flange, depending on the particular application for which the nozzle is to be used.

According to a second aspect of the present invention there is provided a dispensing gun or cartridge for a viscous material, having a dispensing nozzle as hereinbefore described. The dispensing gun or cartridge may preferably be provided with one or more screw thread adaptors to enable the attachment of dispensing nozzles of differing sizes.

According to a third aspect of the present invention there is provided a method of applying a viscous material to a surface comprising the steps of:
attaching a dispensing nozzle as hereinbefore described to a dispensing gun or cartridge housing the viscous material; and
applying the viscous material to the surface via the dispensing nozzle, utilising the flange as a guide and/or finishing tool.

The method may comprise intermediate steps of:
attaching a screw thread adaptor to enable the attachment of a dispensing nozzle to a dispensing gun or cartridge of a differing size; and/or
cutting or trimming the flange and/or the dispensing tip to a desired profile appropriate to the particular application, material and/or surface.

It is envisaged that the improved nozzle of the present invention may find use in a wide variety of applications and with a range of viscous construction materials. In particular, it is envisaged that the flanged nozzle may become a guided tool for use in the glazing industry, enabling greater levels of accuracy when applying mastics and sealants. Particular examples of applications where this will be of relevance are for the joining of glass walls, and for glazing slimline double glazing units into wooden frames. Carrying out jobs such as these using conventional nozzles is often messy and results in a significant amount of wastage. It is envisaged that this will be ameliorated by the use of the flanged nozzle of the present invention, which has been designed to dispense the optimum amount of mastic required without wastage, whilst also enabling a professional finish.

In addition, it is envisaged that the flanged nozzle of the present invention will also be utilised in many other construction and DIY applications such as sealing baths and tiles, and sealing window and door frames to brickwork.

The addition of the flange provides greater flexibility over standard nozzles. The flange provides a finishing tool for use as the mastic or other viscous material is dispensed. In addition to this, the flange can also be custom shaped by cutting or trimming to provide a guide tool to assist with free-hand work. This avoids the need to use additional guide, working, and finishing tools, and also removes the need to use masking tapes or similar, particularly when used for glazing glass into frame rebates. In addition, it has been found that the flanged nozzles of the present invention can be formed using significantly lower amounts of plastics material than conventional nozzles. A standard large size (380 ml) conical nozzle typically has a weight of around 8 g. By comparison, large size variants of the present invention can be formed with weights of 6.8 g for the quadrilateral outlet profile, 6.1 g for the triangular outlet profile, and 5.7 g for the semi-circular outlet profile. A standard small size (310 ml) conical nozzle typically has a weight of around 4 g. By comparison, small thread variants of the present invention can be formed with weights of 3.9 g for the quadrilateral outlet profile, 3.6 g for the triangular outlet profile, 3.5 g for the semi-circular outlet profile. For large-scale production, this can therefore lead to significant cost savings in the amount of polymer used, and indeed in the amount of plastics waste generated.

In order that the present invention may be clearly understood, preferred embodiments and applications thereof will now be described in detail, though only by way of example, with reference to the accompanying drawings, in which:

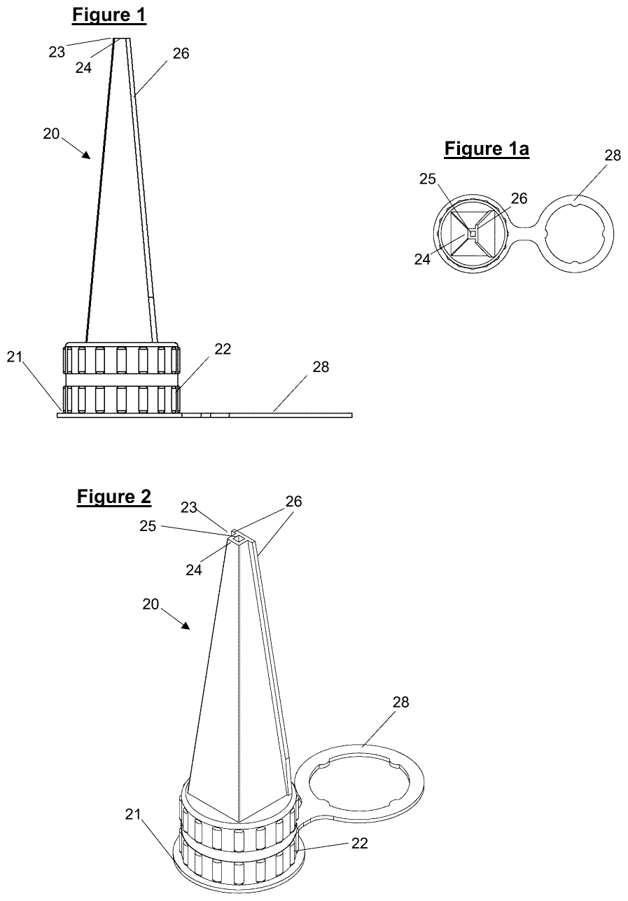

FIG. 1 is a side view of a first embodiment of a dispensing nozzle for a viscous material according to the present invention;

FIG. 1a is an enlarged end view of the dispensing tip of the nozzle of FIG. 1;

FIG. 2 is a perspective view of the dispensing nozzle of FIG. 1;

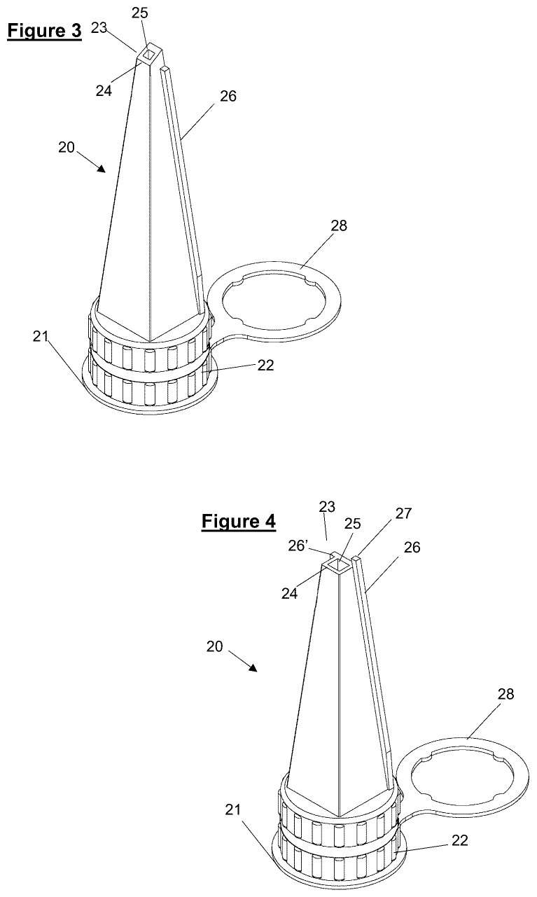

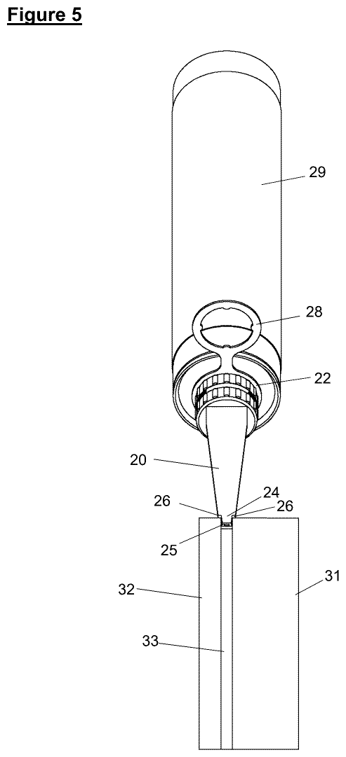

FIGS. 3 and 4 are perspective views of variants of the nozzle of FIG. 1;

FIG. 5 is an illustrative view showing the nozzle of FIG. 3 in use in an embodiment of a method of applying a viscous material to a surface according to the present invention;

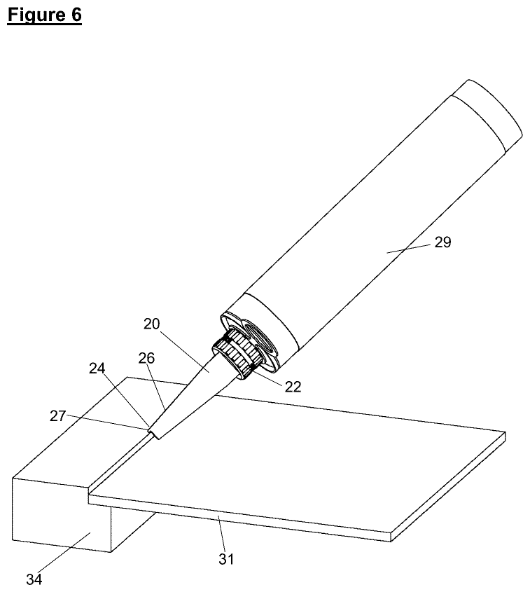

FIG. 6 is an illustrative view showing the nozzle of FIG. 4 in use in an alternative method of applying a viscous material to a surface according to the present invention;

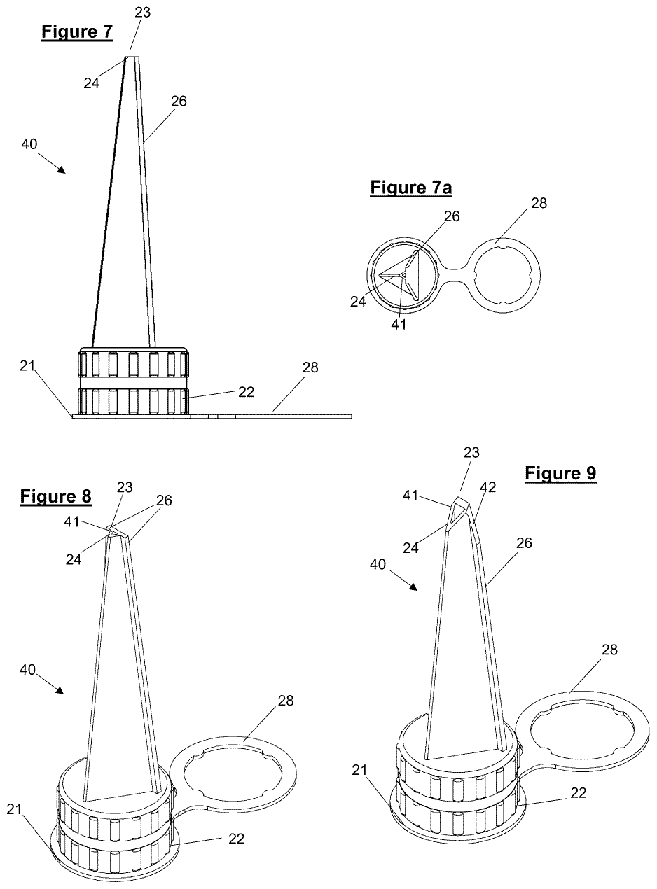

FIG. 7 is a side view of a second embodiment of a dispensing nozzle for a viscous material according to the present invention;

FIG. 7a is an enlarged end view of the dispensing tip of the nozzle of FIG. 7;

FIG. 8 is a perspective view of the dispensing nozzle of FIG. 7;

FIG. 9 is a perspective view of a variant of the nozzle of FIG. 7;

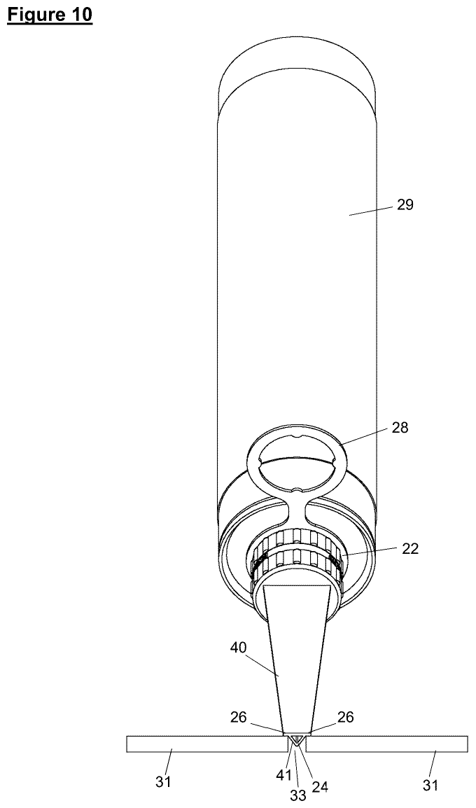

FIG. 10 is an illustrative view showing the nozzle of FIG. 7 in use in a further alternative method of applying a viscous material to a surface according to the present invention;

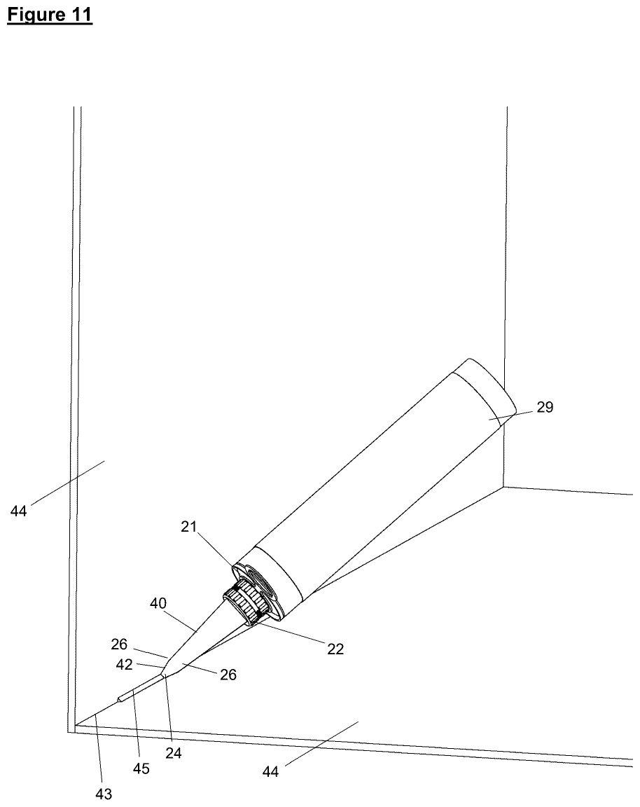

FIG. 11 is an illustrative view showing the nozzle of FIG. 9 in use in a further alternative method of applying a viscous material to a surface according to the present invention;

FIG. 12 is a side view of a third embodiment of a dispensing nozzle for a viscous material according to the present invention;

FIG. 12a is an enlarged end view of the dispensing tip of the nozzle of FIG. 12;

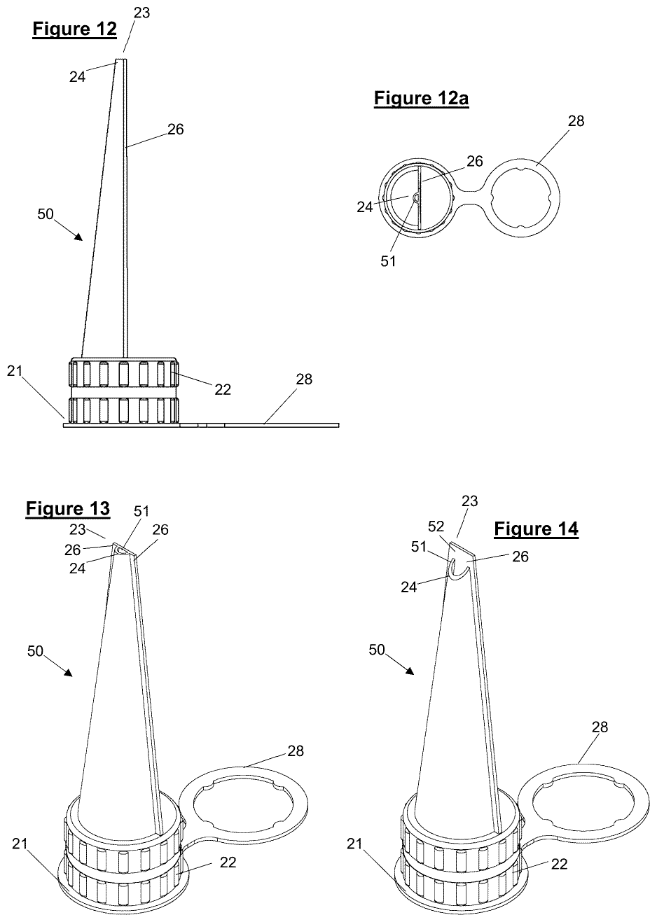

FIG. 13 is a perspective view of the dispensing nozzle of FIG. 12;

FIG. 14 is a perspective view of a variant of the nozzle of FIG. 12;

FIG. 15 is an illustrative view showing the nozzle of FIG. 12 in use in a further alternative method of applying a viscous material to a surface according to the present invention;

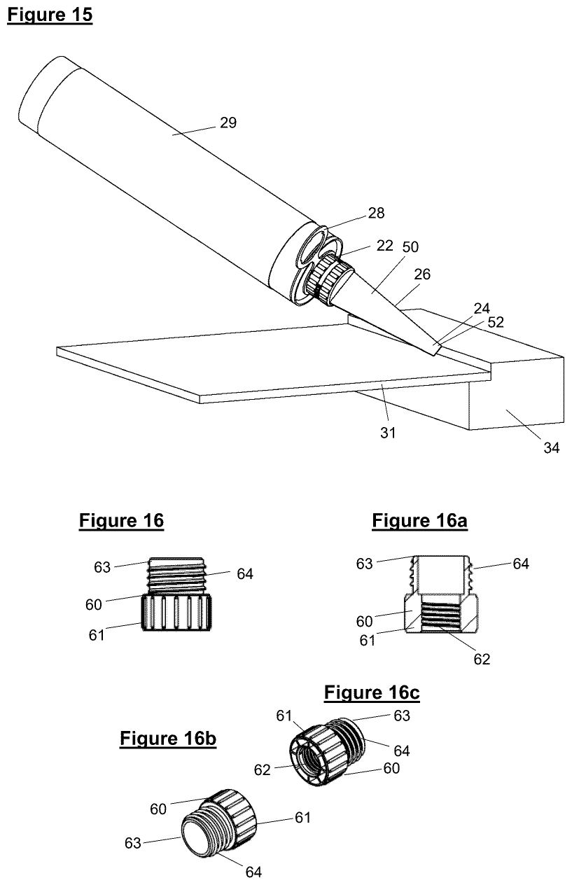

FIG. 16 is a side view of a nozzle adaptor for use with a dispensing nozzle according to the present invention;

FIG. 16a is a cross-sectional view of the nozzle adaptor of FIG. 16; and

FIGS. 16b and 16c are perspective views of the nozzle adaptor of FIG. 16.

Referring first to FIGS. 1 to 2, there is shown a dispensing nozzle, generally indicated 20, for a viscous material, according to a first embodiment of the present invention. The nozzle 20 tapers from a first end 21, having attachment means 22 for attachment to a dispensing gun or cartridge (29, not shown) containing the viscous material, to a second end 23 having a dispensing tip 24. The dispensing tip 24 defines an outlet 25 for the viscous material. As can be seen in FIGS. 1a and 2, in this first embodiment of nozzle 20, the outlet 25 has a quadrilateral (square) profile. As can also be seen from FIG. 2, the nozzle 20 itself is formed with a quadrilateral (square) cross-sectional shape.

The nozzle 20 has a radially projecting flange 26 extending along its exterior surface between the first end 21 and the second end 23. As can be seen from FIG. 2, the flange 26 defines a straight edge of the outlet 25, and extends thereacross to project at both sides of the nozzle 20.

The dispensing tip 24 and the flange 26 are formed from an appropriate grade of plastics material so as to be easily cut or trimmed. In this way the nozzle 20 can be adapted to form a wide range of configurations appropriate to the specific job to be undertaken. Examples of such configurations will be described in more detail below with reference to FIGS. 3 and 4.

The attachment means 22 comprises an internal screw thread (not shown) for attachment to a dispensing gun or cartridge (29, not shown). This may be a standard large or small screw thread, and/or may be utilised in combination with a screw thread adaptor (60, not shown), as will be described in more detail below with reference to FIGS. 16 to 16c. The attachment means 22 also includes a standard securing loop 28.

Referring now to FIG. 3, it can be seen that the dispensing tip 24 has been cut at an angle, so that the outlet 25 is also angled, whilst the flange 26 has been trimmed so as to be stepped back from the second end 23, leaving a portion of the dispensing tip 24 projecting beyond the end of the flange 26. This configuration may find use in a range of applications, but is particularly suitable for jointing structural glazing onto a sub-frame, as will be described in more detail below with reference to FIG. 5.

Referring now to FIG. 4, it can be seen that the dispensing tip 24 has been cut back from the second end 23 and cut straight across so as to present the outlet 25 with a square profile. The flange 26 at one side 26′has been cut flush with the outlet 25, but at the other side has been left untrimmed so as to form a nib 27 projecting beyond the dispensing tip 24. This configuration may find use in a variety of applications, but is particularly suitable for glazing a rebated timber frame, as will be described in more detail below with reference to FIG. 6.

Referring now to FIG. 5, this shows the nozzle 20 of FIG. 3 with the stepped flange 26 configuration in use for the jointing of structural glazing 31 onto a sub-frame 32 with a gap 33 to be sealed defined therebetween. The nozzle 20 is attached to a dispensing cartridge 29 containing mastic to be dispensed. The stepped flange 26 abuts against the surface of the glazing 31 and the sub-frame 32 allowing the dispensing tip 24 with its quadrilateral outlet 25 to protrude into the gap 33. Cutting back the flange 26, as described above with reference to FIG. 3, allows the depth to which the dispending tip 24 protrudes into the gap 33 to be set. The dispensing tip 24 with its square outlet 25 also provides self-tooling for a smooth finish, without the need for additional tools or masking tape.

Referring now to FIG. 6, this shows the nozzle 20 of FIG. 4 with the flange nib 27 configuration, attached to a dispensing cartridge 29, and in use for sealing glazing 31 in a rebated timber frame 34. In this arrangement the nib 27 is used as a self-guiding tool to enable the accurate dispensing of mastic without the need for additional tools.

Referring now to FIGS. 7 to 8, there is shown a dispensing nozzle, generally indicated 40, for a viscous material, according to a second embodiment of the present invention. The nozzle 40 is in most respects the same as the first embodiment 20 described above with reference to FIGS. 1 to 2. However, as can be seen in FIGS. 7a and 8, in this first embodiment of nozzle 40, the dispensing tip 24 defines an outlet 41 having a triangular profile. As can also be seen from FIG. 8, the nozzle 40 itself is formed with a triangular cross-sectional shape.

The configuration shown in FIG. 8 may find use in a variety of applications, but is particularly suitable for jointing glass in parallel, for example in office partitioning, as will be described in more detail below with reference to FIG. 10.

Referring now to FIG. 9, this shows an example of an adapted configuration for the nozzle 40, in which it can be seen that the dispensing tip 24 has been cut at an angle, so that the outlet 41 is also angled, whilst the flange 26 has been trimmed so as to provide an angled shoulder 42 adjacent the dispensing tip 24. This configuration may find use in a variety of applications, but is particularly suitable for sealing an angled joint, as will be described in more detail below with reference to FIG. 11.

Referring now to FIG. 10, this shows the nozzle 40 of FIG. 8, with the flange 26 flush with the outlet 41, attached to a dispensing cartridge 29 and in use for the jointing of glazing 31 in parallel with a gap 33 to be sealed defined therebetween. The flange 26 abuts against the surface of the glazing 31, whilst the triangular shape of the nozzle 40 and outlet 41 allow minimum contact with the sides of the glazing 31, reducing friction and so easing mastic application.

Referring now to FIG. 11, this shows the nozzle 40 of FIG. 9 with the angled shoulder 42 configuration, attached to a dispensing cartridge 29 and in use for sealing and angled joint 43 between two substrates 44. The triangular shape of the nozzle 40 and outlet 41 and the angled shoulders 42 of the flange enable the precise application of a bead of mastic 45 having a smooth flat angled surface, without the need for additional finishing tools.

Referring now to FIGS. 12 to 13, there is shown a dispensing nozzle, generally indicated 50, for a viscous material, according to a third embodiment of the present invention. The nozzle 50 is in most respects the same as the first embodiment 20 described above with reference to FIGS. 1 to 2, and the second embodiment 40 described above with reference to FIGS. 7 to 8. However, as can be seen in FIGS. 12a and 13, in this third embodiment of nozzle 50, the dispensing tip 24 defines an outlet 51 having a generally semi-circular profile. As can also be seen from FIG. 13, the nozzle 50 itself is formed with a generally semi-circular cross-sectional shape.

Referring now to FIG. 14, this shows an example of an adapted configuration for the nozzle 50, in which it can be seen that the dispensing tip 24 has been cut at an angle, so that the outlet 51 is also angled, whilst the dispensing tip 24 has also been cut back leaving an extended flat portion 52 of the flange 26 protruding beyond the dispensing tip 24. This configuration may find use in a variety of applications, but is particularly suitable for glazing a rebated timber frame, as will be described in more detail below with reference to FIG. 15.

Referring now to FIG. 15, this shows the nozzle 50 of FIG. 14 with the extended flange 52 configuration, attached to a dispensing cartridge 29, and in use for sealing glazing 31 in a rebated timber frame 34. In this arrangement the extended flange portion 52 is used as a self-finishing tool to enable the accurate dispensing of a smooth, flat bead of mastic without the need for additional tools.

Referring finally to FIGS. 16 to 16c, there is shown a screw thread adaptor 60, for optional use in combination with the nozzles (20, 40, 50, not shown) of the present invention as described above with reference to FIGS. 1 to 15. The screw thread adaptor 60 has a first end 61 provided with an internal screw thread 62 for engagement with a complementary external screw thread provided on a dispending cartridge (29, not shown), and a second end 63 provide with an external screw thread 64 for engagement with a complementary internal screw thread provided on the attachment means 22 of the nozzles 20, 40, 50. As can best be seen from FIG. 16a, the internal screw thread 62 is smaller than the external screw thread 64, thus enabling the use of standard large size (380 ml) nozzles 20, 40, 50 with standard small size (310 ml) cartridges 29. However, it will be appreciated that the adaptor 60 may also be constructed with a reverse configuration, with the internal screw thread 62 larger than the external screw thread 64, thus enabling the use of standard small size (310 ml) nozzles 20, 40, 50 with standard large size (380 ml) cartridges 29.

1. A dispensing nozzle for a viscous material, comprising:
a first end having attachment means adapted to secure the nozzle to a dispensing gun or cartridge housing said viscous material;
a second end having a dispensing tip defining an outlet for the viscous material, said outlet having a profile comprising at least one straight edge; and
a flange extending longitudinally at least part way along an exterior surface defined between the first end and the second end of the nozzle, said flange projecting radially from said exterior surface.

2. A dispensing nozzle as claimed in claim 1, wherein said viscous material is a construction material selected from mastic, sealant, filler, putty, adhesive, caulk, grout, cement, mortar, silicone, resin, paste, gel, and other viscous fluids and semisolids.

3. A dispensing nozzle as claimed in claim 1, wherein the attachment means comprises an internal screw thread adapted to engage with a complementary external screw thread on said dispensing gun or cartridge.

4. A dispensing nozzle as claimed in claim 3, further comprising one or more screw thread adaptors to enable attachment to dispensing guns or cartridges of differing sizes.

5. A dispensing nozzle as claimed in claim 1, wherein the exterior surface of the nozzle tapers from the first end to the second end.

6. A dispensing nozzle as claimed in claim 1, wherein the outlet has a polygonal profile.

7. A dispensing nozzle as claimed in claim 1, wherein the outlet has a quadrilateral profile.

8. A dispensing nozzle as claimed in claim 1, wherein the outlet has a triangular profile.

9. A dispensing nozzle as claimed in claim 1, wherein the outlet has a semi-circular profile.

10. A dispensing nozzle as claimed in claim 1, wherein the flange projects radially from the exterior surface of the nozzle at both sides thereof.

11. A dispensing nozzle as claimed in claim 1, wherein the radial projection of the flange from the exterior surface has a depth of substantially 1.5 mm.

12. A dispensing nozzle as claimed in claim 1, wherein the flange is colinear with, or parallel to, said at least one straight edge of the outlet.

13. A dispensing nozzle as claimed in claim 1, wherein the longitudinal extension of the flange along the exterior surface of the nozzle projects beyond the outlet at the dispensing tip.

14. A dispensing nozzle as claimed in claim 1, wherein the flange is configured so as to be easily cut, trimmed or removed.

15. A dispensing nozzle as claimed in claim 14, wherein the dispensing tip is configured so as to be easily cut or trimmed.

16. A dispensing gun or cartridge for a viscous material, having a dispensing nozzle as claimed in claim 1.

17. A dispensing gun or cartridge as claimed in claim 16, provided with one or more screw thread adaptors to enable attachment to dispensing nozzles of differing sizes.

18. A method of applying a viscous material to a surface comprising the steps of:
attaching a dispensing nozzle as claimed in claim 1 to a dispensing gun or cartridge housing said viscous material; and
applying the viscous material to the surface via the dispending nozzle, utilising the flange as a guide and/or finishing tool.

19. A method of applying a viscous material to a surface as claimed in claim 18, wherein:
the dispensing nozzle comprises:
a first end having attachment means adapted to secure the nozzle to a dispensing gun or cartridge housing said viscous material;
a second end having a dispensing tip defining an outlet for the viscous material, said outlet having a profile comprising at least one straight edge; and
a flange extending longitudinally at least part way along an exterior surface defined between the first end and the second end of the nozzle, said flange projecting radially from said exterior surface,
wherein the flange is configured so as to be easily cut, trimmed or removed; and
the method comprises an intermediate step of cutting or trimming the flange and/or the dispensing tip to a desired profile appropriate to the particular application, material and/or surface.

20. A method of applying a viscous material to a surface as claimed in claim 18, further comprising a step of attaching a screw thread adaptor to enable the attachment of a dispensing nozzle to a dispensing gun or cartridge of a differing size.
